(19) United States
(12) Patent Application Publication
(10) Pub. No.: US 2019/0327072 A1
(43) Pub. Date: Oct. 24, 2019

(54) TRAINABLE TRANSMITTER LEARN ALGORITHM IMPROVEMENTS

(71) Applicant: Gentex Corporation, Zeeland, MI (US)

(72) Inventors: Todd R. Witkowski, Zeeland, MI (US); Steven L. Geerlings, Holland, MI (US)

(73) Assignee: Gentex Corporation, Zeeland, MI (US)

(21) Appl. No.: 16/385,824

(22) Filed: Apr. 16, 2019

Related U.S. Application Data
(60) Provisional application No. 62/660,487, filed on Apr. 20, 2018.

(51) Int. Cl. H04L 5/26; H04L 1/00; H04L 25/02; H04L 5/14; H04L 5/00

(52) U.S. Cl. CPC H04L 5/26; H04L 1/0071; H04L 5/0005; H04L 5/1469; H04L 25/0206

(57) ABSTRACT

A trainable transmitter comprises a user interface and a memory. The memory comprises control data configured to control a plurality of remote control devices. The transmitter further comprises a transmitter circuit configured to generate and transmit signals in response to an input received by the user interface and comprises a control circuit. The control circuit is configured to retrieve the control data from the memory in response to actuation of the user interface. The control circuit is further configured to control the transmitter circuit to transmit a plurality of control messages comprising coded transmissions for a plurality of remote control devices. The coded transmissions for the remote control devices are interleaved over a shared temporal period.

### CROSS-REFERENCE TO RELATED APPLICATION

This application claims priority to and the benefit under 35 U.S.C. § 119(e) of U.S. Provisional Patent Application No. 62/660,487, filed on Apr. 20, 2018, entitled “TRAINABLE TRANSMITTER LEARN ALGORITHM IMPROVEMENTS,” the disclosure of which is hereby incorporated herein by reference in its entirety.

### TECHNOLOGICAL FIELD

The present disclosure relates generally to the field of trainable transmitters and transceivers for use with vehicles. More specifically, the present invention relates to trainable transmitters and transceivers that are configured for use with remote electronic systems.

### SUMMARY

In one aspect of the disclosure, a trainable transmitter comprises a user interface and a memory. The memory comprises control data configured to control a plurality of remote control devices. The transmitter further comprises a transmitter circuit configured to generate and transmit signals in response to an actuation of the user interface and a control circuit. The control circuit is configured to retrieve the control data from the memory in response to an input received by the user interface. The control circuit is further configured to control the transmitter circuit to transmit a plurality of control messages comprising coded transmissions for a plurality of remote control devices. The coded transmissions for the remote control devices are interleaved over a shared temporal period.

In another aspect of the disclosure, a method for programming a trainable transmitter is disclosed. The method comprises receiving an input activating a programming routine and retrieving control data from a memory in response to the input. The control data comprises a plurality of control messages configured to activate a plurality of remote control devices. The method further comprises generating a signal comprising a plurality of packs of the control messages configured to activate at least two of the remote control devices that are interleaved over a common temporal period. The method further comprises transmitting the control signal over the common temporal period.

In yet another aspect of the disclosure, a trainable transmitter is disclosed. The trainable transmitter comprises a memory comprising control data configured to control a plurality of remote control devices and a transmitter circuit configured to generate and transmit signals in response to an input. The transmitter further comprises a control circuit in communication with the memory and the transmitter circuit. The control circuit is configured to retrieve the control data from the memory. The control data comprises a plurality of control messages forming activation codes configured to activate a plurality of remote control devices. The controller is further configured to control the transmitter circuit to transmit the activation codes. The activation codes are concurrently transmitted during a common temporal period for at least two of the remote control devices.

These and other features, advantages, and objects of the present device will be further understood and appreciated by those skilled in the art upon studying the following specification, claims, and appended drawings.

### BRIEF DESCRIPTION OF THE DRAWINGS

The invention will now be described with reference to the following drawings, in which;

FIG. 1 illustrates a perspective view of a vehicle and a garage comprising a remote electronic system;

FIG. 2 illustrates a block diagram of a system including a transmitter unit in communication with a remote electronic system;

FIG. 3 is a flowchart describing a training method for a transmitter module;

FIG. 4 is a flowchart describing a training method for a transmitter module;

FIG. 5 is a timing diagram demonstrating a message transmission sequence for a transmitter module; and

FIG. 6 is a timing diagram demonstrating a message transmission sequence for a transmitter module in accordance with the disclosure.

### DETAILED DESCRIPTION OF EMBODIMENTS

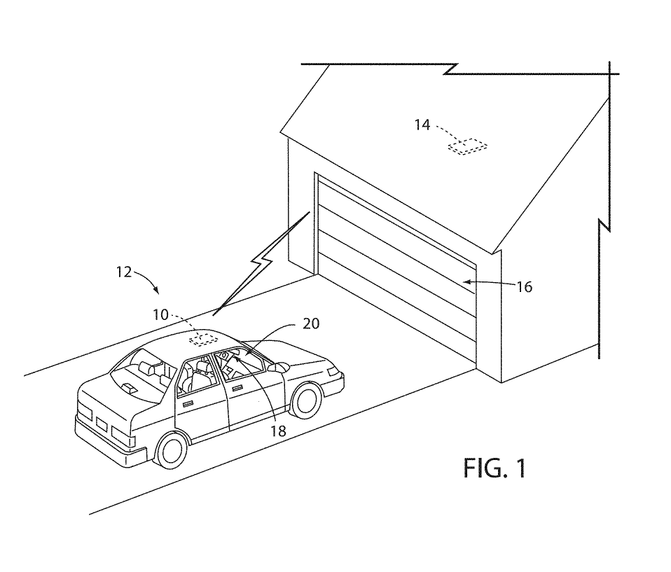

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the surface of the element closer to an intended viewer of the display mirror, and the term “rear” shall refer to the surface of the element further from the intended viewer of the display mirror. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

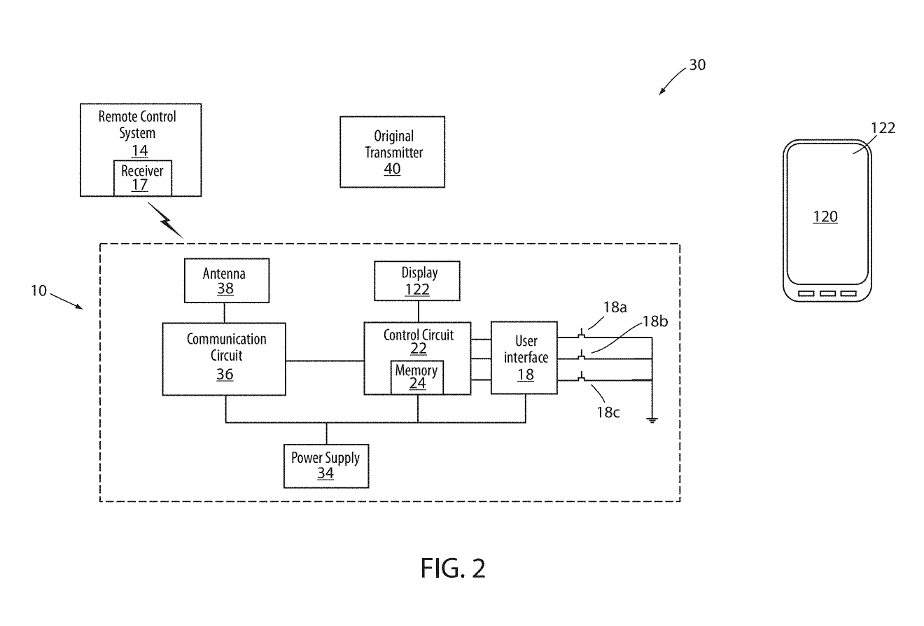

Referring generally to the FIGS. 1 and 2, the disclosure provides for devices and methods for implementing a transmitter module 10 (e.g., a transmitter or transceiver) shown implemented in a vehicle 12. The transmitter module 10 may be configured to transmit a plurality of messages via various wireless communication protocols. In various embodiments, the messages may be configured to wirelessly communicate with one or more remote electronic systems 14 to activate or control various devices (e.g., a garage door opener 16). In operation, the transmitter module 10 may be activated to transmit one or more preconfigured messages as wireless control signals in response to an input received via a user interface 18. The user interface 18 may be incorporated in a passenger compartment 20 of the vehicle 12 such that a vehicle operator or passenger may access the user interface 18 and remotely control the remote electronic system 14.

In operation, the transmitter module 10 may be enabled by actuating one of a plurality of interface elements 18a, 18b, 18c of the user interface 18. In response to the input received by each of the interface elements 18a, 18b, and 18c; a control circuit 22 of the module 10 may transmit a preconfigured wireless transmission via an associated wireless communication protocol. Though operation of the module 10 may be simple, programming the control circuit 22 to assign communication messages and protocols to each of the interface elements 18a, 18b, 18c may be complicated. The complexity of programming may be related to the complexity of programming procedures that often must be completed in a limited period of time. The limited period of time may be associated with a code training period of the remote electronic system 14.

The transmitter module 10, may be configured to be programmed to communicate characteristic signals associated with multiple remote control devices (e.g., a remote control for a garage door, a security gate, a home lighting system, a home security system, etc.). The programming information of the transmitter module 10 may be stored in a memory 24 of the control circuit 22 for later transmission. The later transmission may be activated in response to an input received by the control circuit 22 from an associated switch of the interface elements 18a, 18b, 18c.

Though the example shown in FIG. 1 demonstrates the remote electronic system 14 as being associated with the garage door opener 16, the transmitter module 10 may be utilized to control a variety of remote electronic systems 14. The remote electronic system 14 may comprise a receiver circuit 17 and/or an emitter circuit. In some embodiments, remote electronic systems 14 may correspond to a home lighting system, a home security system, a data network (e.g., LAN, WAN, cellular, etc.), a heating, ventilation and air conditioning (HVAC) system, or any other remote electronic system 14 capable of receiving control signals from transmitter module 10.

Referring now to FIG. 2, a block diagram of a system 30 comprising the transmitter module 10 in communication with the remote electronic system 14 is shown. In the exemplary embodiments, the transmitter module 10 is shown comprising the user interface elements 18, the control circuit 22, a communication circuit 36, and a power supply 34. The user interface 18 may facilitate communication between a user (e.g., driver, passenger, or other occupants of vehicle 12) and the transmitter module 10. For example, user interface elements 18a, 18b, 18c may be used to receive inputs from a user to program the transmitter module 10 and/or to control transmissions to the remote electronic system 14.

The user interface elements 18a, 18b, 18c may include one or more push buttons, switches, dials, knobs, touch-sensitive devices (e.g., piezoelectric sensors, capacitive touch sensors, etc.), or other devices for translating a tactile of proximity inputs into electronic data signals. Advantageously, the user interface 18 may be integrated with a rearview mirror assembly of vehicle 12. For example, the user interface 18 may include one or more pushbuttons (e.g., mounted along a bottom surface of a rearview mirror assembly). The user interface 18 may provide input signals to the control circuit 22 for controlling operation of the transmitter module 10.

The control circuit 22 may be configured to receive input from user input devices (e.g. an original transmitter 40). In some embodiments, the control circuit 22 may comprise the memory 24, which may be configured to store programming information defining the signals that may be communicated from the transmitter module 10. The control circuit 22 may comprise one or more processors, which may be implemented as general purpose processors, microprocessors, microcontrollers, application specific integrated circuits (ASICs), or other suitable electronic processing components.

The memory 24 may include one or more devices (e.g., RAM, ROM, Flash® memory, hard disk storage, etc.) for storing data and/or computer code for completing and/or facilitating the various processes, layers, and modules described in the present disclosure. The memory 24 may comprise volatile memory or non-volatile memory. In various embodiments, the memory 24 may include look-up tables, database components, object code components, script components, or any other type of information structure for supporting the various activities and information structures described herein.

The communication circuit 36 comprises an antenna 38 and may be configured to transmit and/or receive wireless communications at a variety of carrier frequencies. The communication circuit 36 may be configured to transmit wireless control signals having control data for the controlling of various remote electronic systems (e.g., the remote electronic system 14). In some embodiments, the communication circuit 36 may further be configured to receive wireless status signals including status information from remote electronic system 14. In such embodiments, the transmitter module 10 and remote electronic system 14 may communicate using any suitable wireless standard (e.g., Bluetooth®, WiFi®, WiMAX®, etc.) or other communication protocols compatible with or proprietary to the remote electronic system 14. In such embodiments, the transmitter module 10 may be configured to learn and replicate control signals using any wireless communications protocol.

As previously discussed, the transmitter module 10 may be configured such that each of the interface elements 18a, 18b, 18c activate the control circuit 22 to communicate wireless control signals configured to control programmed devices, such as the garage door opener 16 of the remote electronic system 14. In order to configure or designate the control signals and protocols associated with the interface elements 18a, 18b, 18c, the control circuit 22 may be programmed via a variety of programming routines. The programming routines may require interaction with a user of the transmitter module 10 identifying which codes or transmissions are effective in controlling each of the remote electronic systems 14 to be associated with the interface elements 18a, 18b, 18c.

In some embodiments, the programming routines of the transmitter module 10 may be initiated by holding or pressing one or more of the interface elements 18a, 18b, 18c for a predetermined period of time. Additionally, a training mode of the remote electronic system 14 may be activated during the programming routines such that the remote electronic system 14 is configured to receive a programming activation signal similar to that associated with an original transmitter 40 or user input device of the remote electronic system 14. For example, the original transmitter 40 may be a hand-held garage door opener transmitter configured to transmit a garage door opener signal at a frequency (e.g., centered around 315 MHz, 390 MHz, and 433.92 MHz, etc.). The activation signal may include control data, which can be a fixed code, a rolling code, or another cryptographically-encoded code. Remote electronic system 14 may be configured to open a garage door, for example, in response to receiving the activation signal from the original transmitter 40.

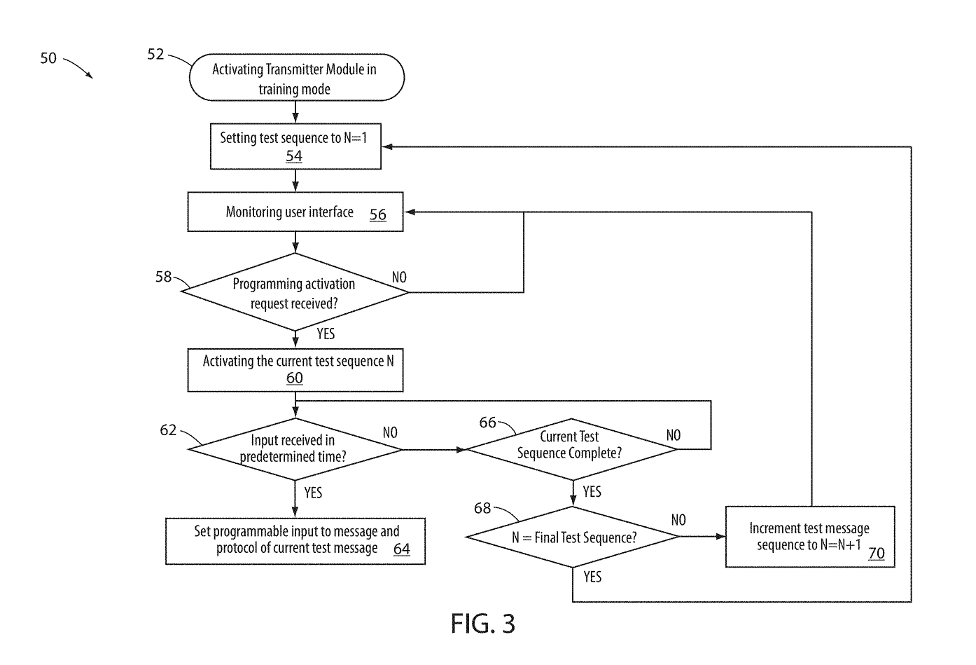

A number of exemplary programming routines for the transmitter module 10 are discussed in reference to FIGS. 3-6. Generally, the programming routines may be achieved via one or more improved methods that systematically activate and test each of the activation signals of the remote electronic system 14. Such methods may operate by accessing each of the activation signals from the memory 24. The activation signals may be programmed into the memory 24 during the manufacture of the transmitter module 10. In order to program the activation signals to the interface elements 18a, 18b, 18c, the control circuit 22 may transmit each of the activation signals in a variety of ways until one of the activation signals causes the remote electronic system 14 to operate (e.g., the garage door opener 16 opens/closes). Once the remote electronic system 14 is activated and controlled by the transmitter module 10, a user of the transmitter modules 10 may provide an input to the user interface 18 thereby indicating successful programming of the transmitter module 10.

The communication circuit 36 may be configured to generate a carrier frequency at any of a number of frequencies (e.g., in response to a control signal from control circuit 22). In some embodiments, the frequencies generated can be in the ultra-high frequency range (e.g., between 20 and 470 megahertz (MHz), between about 20 and 950 MHz, between about 280 and 434 MHz, up to 868 MHz, up to 920 MHz, up to 960 MHz, etc.) or in other frequency ranges. The control data modulated with the carrier frequency signal may be frequency shift key (FSK) modulated, amplitude shift key (ASK) modulated, On-off key (OOK) modulated, or modulated using another modulation technique. The communication circuit 36 may be configured to generate a wireless control signal having a fixed code, a rolling code, or other cryptographically encoded control code suitable for use with remote electronic system 14.

In general, the methods discussed herein may provide for improved routines for transmission of the messages included in each of the activation signals for the compatible remote electronic systems. Each of the activation signals for the remote electronic systems 14 may be stored in an ordered sequence or otherwise prioritized in the memory 24 such that the control circuit 22 may access and selectively transmit each of the activation signals. One of the main problems that can occur during such an activation and test routine is that the time available to test all of the potential activation signals expires prior to completion of the programming routine. In such circumstances, the user may typically be forced to start the entire programming routine over. This process may be frustrating to users due to the time lost in restarting the programming routine.

Referring now to FIG. 3, a flowchart is shown demonstrating a method 50 for a programming routine for the transmitter module 10. The method 50 may begin in response to an activation of the transmitter module 10 in a training mode (52). Once activated, the control circuit 22 of the module 10 may set a current test sequence (N) of a test signal activation sequence to a first sequence N=1 (54). The control circuit 22 may then monitor the interface elements 18a, 18b, 18c of the user interface 18 for a programming activation input (56). The control circuit 22 may then proceed to step 58 to determine if the programming activation input is received. The programming activation input may correspond to a detection of one or more of the interface elements 18a, 18b, 18c being actuated for a predetermined period of time.

If the programming activation input is not received in step 58, the control circuit 22 may continue to monitor the user interface 18 for an input. If the programming activation input is received in step 58, the control circuit 22 may continue to activate an activation code test routine (60). As previously discussed, the test routine may be processed by the control circuit 22 by sequentially accessing and transmitting the activation signals for the compatible remote electronic systems. The test routine may begin by setting the current test sequence N to the first sequence N=1 as set in response to the activation in step 54. The control circuit 22 may then continue to transmit each of the different activation signals for the compatible remote electronic systems.

During the test routine, the control circuit 22 may monitor the user interface 18 to identify an input received from a user in step 62. If an input is received in step 62, the control circuit 22 may program the input received (e.g., 18a) to activate the control circuit 22 to transmit activation signals having the protocol of one of the signals within the current test sequence (e.g., N=1) (64). Thereafter, in response to an input received by the interface element (e.g., 18a), the control circuit 22 may control the communication circuit 36 to communicate the activation signal associated with the current messaging protocol of the test routine (e.g., N=1). That is, if the input is received during step 62 during the predetermined period of time, the programming for the interface element that receives the input will be completed by programming the current messaging protocol of the test routine to be controlled by later inputs of the selected interface element (e.g. 18a).

If an input is not received within the predetermined time, the method 50 may continue to step 66, wherein the control circuit 22 may determine if a current test sequence N is complete. If the current test sequence N is not complete, the control circuit 22 may return to step 62. If the current test sequence N is complete, the control circuit 22 may continue to determine if N is the final test sequence of the test routine (68). If the current sequence N is not the final test sequence of the test routine, the control circuit 22 may continue to step 70 to increment the current test sequence of the test routine to N=N+1. The control circuit 22 may then return to step 56 to monitor the user interface 18. When returning to step 56, the position N of the test routine may be maintained such that if the programming is activated again, the control circuit 22 may begin the test sequence at the position N where the previous test left off.

If the current sequence N is the final test sequence of the test routine, the control circuit 22 may continue to step 54 and set the current test sequence N to the first sequence N=1. In this way, the control circuit 22 may be reset to begin the test routine with the first test sequence in response to a later activation of the test routine via user interface 18. In this way, the method 50 may provide for improved user interaction with the transmitter module 10.

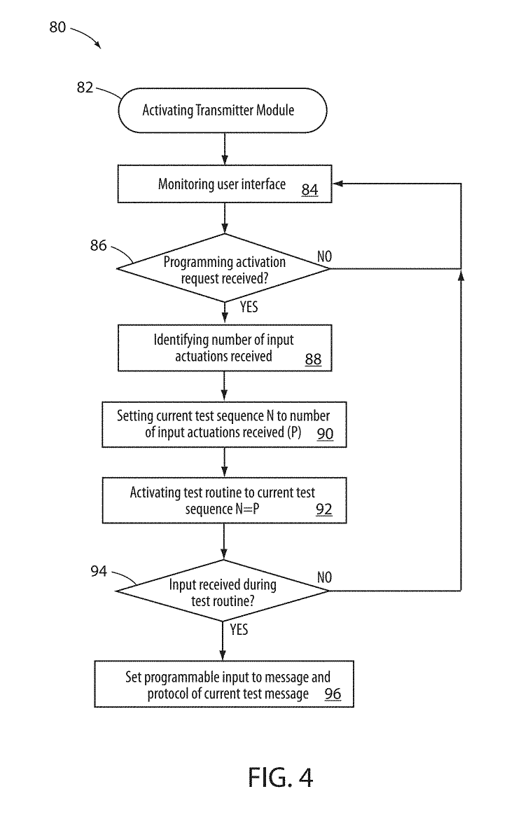

Referring now to FIG. 4, a flowchart is shown demonstrating a method 80 for a programming routine for the transmitter module 10. The method 80 may begin in response to an activation of the transmitter module 10 (82). Once activated, the control circuit 22 may monitor the interface elements 18a, 18b, 18c of the user interface 18 for a programming activation input (84). The control circuit 22 may then proceed to step 86 to determine if the programming activation input is received. The programming activation input may correspond to a detection of one or more of the interface elements 18a, 18b, 18c being actuated for a predetermined period of time. In particular, the programming activation may further include a number of input actuations of one or more of the interface elements 18a, 18b, 18c.

If the programming activation input is not received in step 86, the control circuit 22 may continue to monitor the user interface 18 for an input. If the programming activation input is received in step 86, the control circuit 22 may continue to detect a number of input actuations P of one or more of the interface elements 18a, 18b, 18c (88). Based on the number of input actuations P received via the user interface 18, the control circuit 22 may set the current test sequence N of an activation code test routine to the number of input actuations P (90). As previously discussed, the test routine may be processed by the control circuit 22 by sequentially accessing and transmitting the activation signals to the compatible remote electronic systems.

Once the current test sequence N of the test routine is identified, the control circuit 22 may begin the test routine at the selected current test sequence N=P as set in response to the activation in step 88 (92). Following the activation, the control circuit 22 may continue to sequentially transmit each of the different activation signals for the compatible remote electronic systems for a predetermined time. The control circuit 22 may then monitor the user interface 18 to identify an input received from a user in step 94 during the test routine. If an input is received in step 94, the control circuit 22 may program the input received (e.g., 18a) setting the programming for the input (e.g., 18a) to a message and protocol of a current test message within the current test sequence (e.g., N=P) (96). Thereafter, in response to an input received by the interface element (e.g., 18a), the control circuit 22 may control the communication circuit 36 to communicate the activation signal associated with the current test sequence N when the input was received. If an input is not received during the test routine in step 94, the method 80 may return to step 84 to monitor the user interface 18.

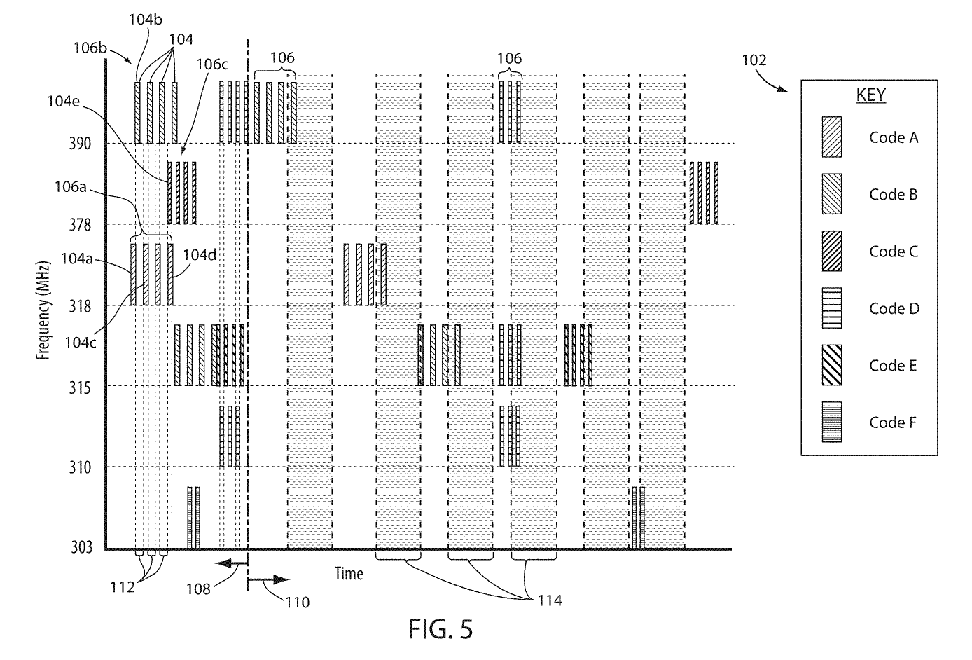

Referring now to FIG. 5, a timing diagram is shown demonstrating a message transmission sequence for an exemplary embodiment of the transmitter module 10. As demonstrated, the transmission sequence comprises a plurality of code types 102. The code types 102 demonstrate various types of codes that may be communicated by various standard or proprietary protocols (e.g., Keeloq rolling code, fixed-code, billion code, etc.). The exemplary code types 102 shown in FIG. 5 include the following: Code A, Code B, Code C, Code D, Code E, and Code F. Each of the codes may comprise a plurality of messages 104, which may be grouped in packs 106 or bursts communicated at one or more frequencies (e.g., 303 MHz, 310 MHz, 315 MHz, etc.).

The messages 104 may be grouped into packs 106 sent in groups to communicate the complete activation codes for each of the code types 102. In order to activate the remote electronic system 14, each of the code types 102 may send two or more packs 106 of the messages 104. For clarity, an initial packet will be referred to as an initialization signal 108 and a second, later transmission will be referred to as an activation signal 110. The initialization signals 108 are shown grouped in a first time period and the activation signals 110 are grouped in a second time period. Each of the signals depicted in FIG. 5 for the code types 102 comprises initialization signal 108 and a later activation signal 110. In general, the initialization signals 108 may be communicated to the remote electronic system 14 identifying a secure device (e.g., the transmitter module 10) is in communication, and the activation signal 110 may initiate the remote electronic system 14 to activate a control sequence (e.g., control the garage door opener 16). Though described as requiring an initialization signal 108 and an activation signal 110, some systems may require three or more messages 104 to complete a training sequence. It shall be understood that the disclosure may be implemented with such systems without departing from the spirit of the disclosure.

In some embodiments, the transmitter module 10 may be configured to interleave messages 104 for different code types 102 at different frequencies. Additionally, in some embodiments, the transmitter module 10 may be configured to send messages 104 for different code types 102 and different frequencies at the same time. In such application, the transmitter module 10 may comprise a plurality of transmitter circuits. In this way, the transmitter module 10 may be configured to condense the packs 106 comprising the messages 104 for various activation signals for each of the code types 102 to decrease a transmission time necessary to communicate the messages 104 to the remote electronic system 14.

For example, the transmission sequence may begin by transmitting a first message 104a of Code A for a first packet 106a. Following the initiation of the transmission of the first message 104a of Code A, the control circuit 22 may control the communication circuit 36 to also begin a transmission of a second message 104b of Code B for a second packet 106b. After the second message 104b of Code B, the control circuit 22 may further control the communication circuit 36 to transmit a third message 104c of the first packet 106a of Code A. In this way, the control circuit 22 may be configured to interleave messages 104 of the second packet 106b of Code B during null transmission periods 112 within the first packet 106a of Code A. By interleaving the messages 104, the control circuit 22 may be configured to transmit the activation codes by interleaving the messages 104 forming each of the packs 106 of different codes, which may be transmitted at different carrier frequencies.

Additionally, in some embodiments, the control circuit 22 may control the communication circuit 36 to transmit two or more of the code types 102 during a common temporal period. For example, a fourth message 104d of Code A may be transmitted at the same time as a fifth message 104e in a third packet 106c of Code C. As shown, Code A and Code C are transmitted at different frequencies such that communicating the messages 104 or packs 106 at the same time may not result in communication interference as received by the remote electronic system 14. Since the remote electronic system 14 may only be configured to detect a specific code, the simultaneous transmission of Code A and Code C, or any codes at different frequencies may not cause reception interference for the activation of the programming for the remote electronic system 14. Accordingly, the transmitter module 10 may be configured to limit the transmission time of a large number of code types 102 by simultaneously transmitting messages 104 from different code types 102 at different carrier frequencies.

As discussed herein, the different code types 102 may be transmitted simultaneously and/or in rapid succession. Such transmissions may be emitted from the transmitter module 10 as a sequence of consecutive messages that may be interleaved among one another or rapidly transmitted as a burst transmission. In some examples, the simultaneous transmission of the messages 104 may be provided by transmitting the messages concurrently over different carrier frequencies. In this configuration, the transmitter module 10 may be configured to transmit messages 104 for more than one of the different code types 102 simultaneously over multiple carrier frequencies. In this way, the transmitter module may be configured to efficiently transmit the messages 104 for various code types over a common temporal period by interleaving and/or simultaneously transmitting the messages 104 as discussed herein.

Finally, in order to accurately identify which of the code types 102 causes the remote electronic system 14 to activate (e.g., control the garage door opener 16), the control circuit 22 may be configured to transmit each of the activation signals 110 for the code types 102 with a user response delay 114 following each. During the user response delay 114, a user of the transmitter module 10 may have time to identify that the remote electronic system 14 is responsive to the activation signal 110 and confirm the programming of the transmitter module 10 by actuating one of the interface elements 18a, 18b, 18c.

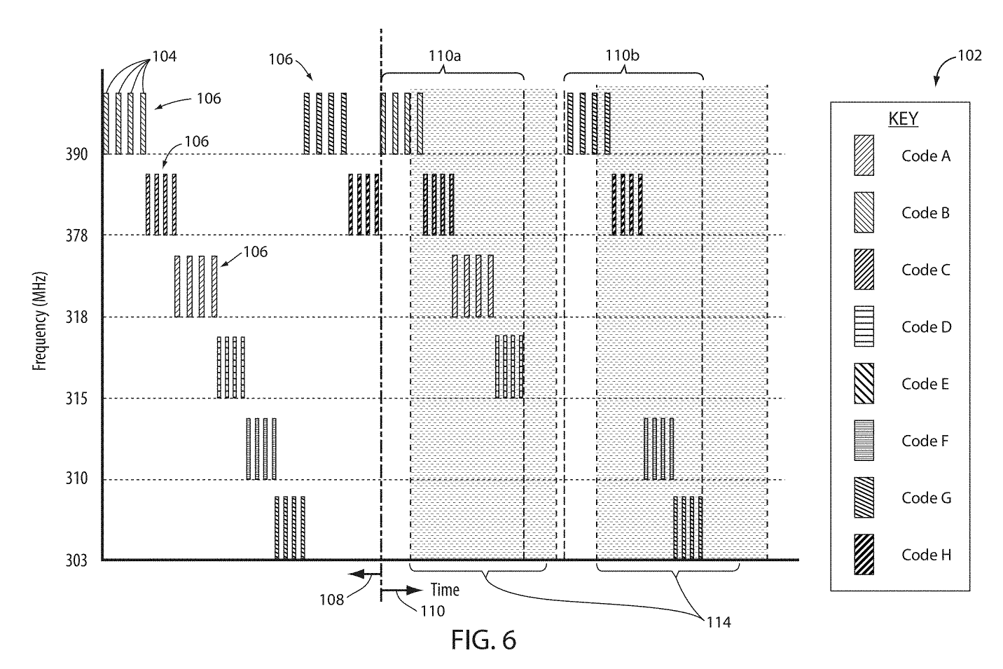

Referring now to FIG. 6, a timing diagram is shown demonstrating a message transmission sequence for the transmitter module 10. As shown, the transmission sequence comprises the plurality of code types 102 transmitted sequentially at different carrier frequencies. Following the transmission of the initialization signals 108, the activation signals 110 may be transmitted similarly during a second time period. However, in the transmission sequence of FIG. 6, the activation signals 110 for the different code types 102 are also grouped together in a first group 110a and a second group 110b. As previously discussed, some training sequences may require 3 or more signals. In such cases, the activation signals 110 may be transmitted as second transmission signals and third transmission signals following similar transmission strategies and timing over a longer period of time. Accordingly, the systems and methods described herein may be implemented in a variety of ways to suit a desired training routine.

The first group 110a of the code types 102 may be programmed to be transmitted sequentially over a first common temporal period to activate remote electronic systems 14 responding to Code A, Code B, Code C, or Code D. The second group 110b of the code types 102 may be programmed to be transmitted sequentially over a second common temporal period to activate remote electronic systems responding to Code E, Code F, Code G, or Code H. In this way, a single input received by the user interface 18 may be configured to initiate the control circuit 22 to transmit the code types in the first group 110a or the second group 110b. Accordingly, the transmitter module 10 may be configured to transmit activation signals for a plurality of remote electronic systems 14 in response to receiving a single input via the interface elements 18a, 18b, 18c.

As shown in FIG. 6, the user response delay 114 is still provided in the sequence, but, instead of identifying a single code type 102, the control circuit 22 may be configured to identify a plurality of code types 102 in each of the groups 110a, 110b. Accordingly, a user input received by the user interface 18 during each of the user response delay periods 114 may program the corresponding interface element (e.g., 18a, 18b, 18c) to transmit each of the corresponding code types 102 in the first group 110a or the second group 110b upon later actuations of the selected interface element. Though a specific code type may never be identified in this approach, the communication between the transmitter module 10 and the remote electronic system 14 may be achieved with a shorter time duration required to complete the programming procedure. An additional benefit of this approach is that the response delay period 114 (i.e., the window in which the user may press the interface element of the user interface 18 to indicate successful programming of the remote electronic system 14) can be longer making it easier for the user to successfully program the transmitter module 10.

Referring again to FIG. 2, in some embodiments, the transmitter module 10 may include or be in communication with a mobile device 120 comprising a display 122. The display 122 may be utilized in combination with the user interface 18 of the transmitter module 10 or the mobile device 120 to prompt a user to identify a code type 102 or manufacturer of the remote electronic system 14 after the initialization signals 108 are communicated. In the configuration, a user of the transmitter module 10 may be able to interact with the display 122 and the user interface 18 to scroll through each of the code types 102 shown on the display 122.

Based on the code types 102 shown on the display 122, the user may identify a code type, manufacturer, or model of the remote electronic system 14. The user may then select the code type and, in response to the selection, the transmitter module 10 may send the activation signal 110 for the selected remote electronic system 14. Upon verification that activation signal 110 controls the remote electronic system 14, the user may provide a verification input to the user interface 18 to complete the programming of the transmitter module 10. Additionally, if a user did not know the specific code type for the remote electronic system 14, the user could use the information on the display 122 as a reference to sequentially test each of the code types shown on the display 122.

The display 122 may correspond to a light emitting diode (LED) display, a liquid crystal display (LCD), a vacuum fluorescent display (VFD), or other display elements. The mobile device 120 may correspond to various forms of portable devices including, but not limited to, smartphones, laptop computers, personal data assistants, tablets, etc. The transmitter module 10 may communicate with the mobile device 120 via a wireless communication protocol (e.g., Bluetooth®, WiFi®, WiMAX®, etc.) or other communication protocols compatible with the mobile device 120.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A trainable transmitter, comprising:
a user interface;
a memory comprising control data configured to control a plurality of remote control devices;
a transmitter circuit configured to generate and transmit signals in response to actuation of the user interface; and
a control circuit in communication with the user interface, the memory, and the transmitter circuit, wherein the control circuit is configured to:
retrieve the control data from the memory in response to an input received by the user interface; and
control the transmitter circuit to transmit a plurality of control messages comprising coded transmissions for a plurality of remote control devices, wherein the coded transmissions for the remote control devices are interleaved over a shared temporal period.

2. The trainable transmitter according to claim 1, wherein the coded transmissions comprise the plurality of control messages communicated in packs.

3. The trainable transmitter according to claim 2, wherein the control messages of each of the packs are interleaved over the shared temporal period.

4. The trainable transmitter according to claim 2, wherein the packs comprise at least a first packet and a second packet.

5. The trainable transmitter according to claim 4, wherein the first packet comprises a first code type configured to communicate with a first remote control device and the second pack comprises a second code type configured to communicate with a second remote control device of the plurality of remote control devices.

6. The trainable transmitter according to claim 5, wherein the first code type comprises an activation signal for the first remote control device and the second code type comprises an activation signal for the second remote control device.

7. The trainable transmitter according to claim 5, wherein the coded transmission of the first pack comprises a first message and a second message, and the coded transmission of the second pack comprises a third message and a fourth message.

8. The trainable transmitter according to claim 7, wherein the control circuit is further configured to:
control the transmitter circuit to transmit the third message of the second pack between the first message and the second message of the first pack thereby interleaving the first code type with the second code type over the shared temporal period.

9. The trainable transmitter according to claim 1, wherein the coded transmissions for the remotely controlled devices are sent at a plurality of carrier frequencies.

10. The trainable transmitter according to claim 9, wherein the coded transmissions at the plurality of carrier frequencies are transmitted simultaneously at the plurality of carrier frequencies.

11. A method for programming a trainable transmitter, comprising:
receiving an input activating a programming routine;
retrieving control data from a memory in response to the input, wherein the control data comprises a plurality of control messages configured to activate a plurality of remote control devices;
generating a signal comprising a plurality of packs of the control messages, wherein the messages configured to activate at least two of the remote control devices are interleaved over a common temporal period; and
transmitting the control signal over the common temporal period.

12. The method according to claim 11, wherein transmitting the signal comprises transmitting the plurality of packs at a plurality of carrier frequencies over the common temporal period.

13. The method according to claim 11, wherein the plurality of carrier frequencies comprise a first carrier frequency and a second carrier frequency and wherein the transmitting comprises transmitting a first message of the control messages at a first carrier frequency concurrently with a second message of the control messages at a second carrier frequency.

14. The method according to claim 13, wherein the first message is configured to activate a first remote control device of the plurality of remote control devices and the second message is configured to activate a second remote control device of the plurality of remote control devices.

15. The method according to claim 11, wherein the plurality of packs form a first code configured to activate a first device of the remote control devices and a second code configured to activate a first device of the remote control devices, wherein the packs of the first code and the second code are interleaved over the common temporal period.

16. The method according to claim 15, wherein the first code comprises at least one null transmission period.

17. The method according to claim 16, wherein at least one control message of the second code is transmitted during the null transmission period of the first code.

18. A trainable transmitter, comprising:
a memory comprising control data configured to control a plurality of remote control devices;
a transmitter circuit configured to generate and transmit signals in response to an input; and
a control circuit in communication with the memory and the transmitter circuit, wherein the control circuit is configured to:
retrieve the control data from the memory, wherein the control data comprises a plurality of control messages forming activation codes configured to activate a plurality of remote control devices; and
control the transmitter circuit to transmit the activation codes, wherein activation codes are concurrently transmitted during a common temporal period for at least two of the remote control devices.

19. The trainable transmitter according to claim 18, wherein a first activation code of the plurality of activation codes comprises the control messages combined in a first pack and a second pack separated temporally by a null transmission period.

20. The trainable transmitter according to claim 19, wherein a second activation code of the plurality of activation codes comprises the control messages combined in a third pack, wherein the controller is configured to transmit at least a portion of the third pack during the null transmission period between the first pack and the second pack.
